(19) United States
(12) Patent Application Publication
(10) Pub. No.: US 2002/0011135 A1
(43) Pub. Date: Jan. 31, 2002

(54) Reversible socket wrench set

(76) Inventor: Wayne Hall, Ellwood City, PA (US)

Correspondence Address: Joseph G. Nauman, 696 Renolda Woods Ct., Dayton, OH, 45429-3415, US

(21) Appl. No.: 09/884,385

(22) Filed: Jun. 19, 2001

Related U.S. Application Data
(60) Provisional application No. 60/212,402, filed on Jun. 19, 2000.

(51) Int. Cl. B25B 13/00

(52) U.S. Cl. 81/124.4

(57) ABSTRACT

A set of dual (double ended) socket wrenches, are provided wherein each of the socket wrenches is of different but related size with respect to each other, and each dual wrench has a common drive socket between the socket wrenches, and an adaptor drive tool for the entire set. The drive socket may be of the same size as the smallest socket wrench in the set, otherwise the drive socket is of smaller size than the two sockets of a dual socket wrench.

### RELATED APPLICATION

This application relates to, and claims the filing date of, U.S. Provisional Application Ser. No. 60/212,402 filed Jun. 19, 2000, entitled REVERSIBLE SOCKET WRENCH SET.

### BACKGROUND OF THE INVENTION

Most automobiles have only one or two sizes of bolts or screws for the sheet metal panels on the front end of the automobile, and many of the auto's mechanical components will use only one or two bolt/nut sizes. For example, a large number of repairs can be made on a Ford vehicle using just a 10mm and a 13mm socket. It therefore would be convenient and expedient for the mechanics to have one double ended socket combining those two sizes.

### SUMMARY OF THE INVENTION

The present invention provides a set of double ended or dual socket wrenches, the two socket wrenches being of different but related sizes, and having a common drive receptor or socket between the socket wrenches, and an adaptor drive tool for the entire set. In most cases the drive receptor or socket will be of different size than the two sockets, however in certain instances where the adaptor is the same size (e.g. 7 mm. hex configuration) as one of the drive sockets, the receptor/drive socket may be an extension of that same size and configuration into the center of the double ended socket.

Such a dual socket tool set provides a convenient arrangement for the mechanic, since he can simply invert the desired active end of these dual socket tools onto and off the adaptor as he proceeds to disassemble and/or assemble parts during the process of repair and/or servicing.

### BRIEF DESCRIPTION OF THE DRAWINGS

FIGS. 1A, 1B, and 1C are respectively an end view of the driven (female) end of a common drive adapter for a set of double ended sockets wrenches, a side view of the common drive adaptor, and an end view of the drive end (male, hexagonal) of such adaptor;

FIGS. 2A, 2B and 2C are, respectively, a plan view of the larger socket end of a dual socket tool according to the invention, a longitudinal cross-section view through that tool, and an end view of the other socket end of that tool, which extends into the center of the tool and provides also the adaptor socket;

FIGS. 3A, 3B, and 3C are, respectively, a end view of the larger socket end of a dual socket tool according to the invention, a cross-sectional view illustrating the two socket wrenches and the intermediate socket receptor for the drive adaptor:

FIG. 4 is an exploded perspective view of a square drive on a ratchet driver, aligned with the drive adapter for the set of dual socket wrenches, which is in turn aligned with the hex socket drive receptor of one of the dual socket wrenches of the set; and

FIG. 5 is an illustration of a complete set of dual socket wrenches with the drive adapter for the set.

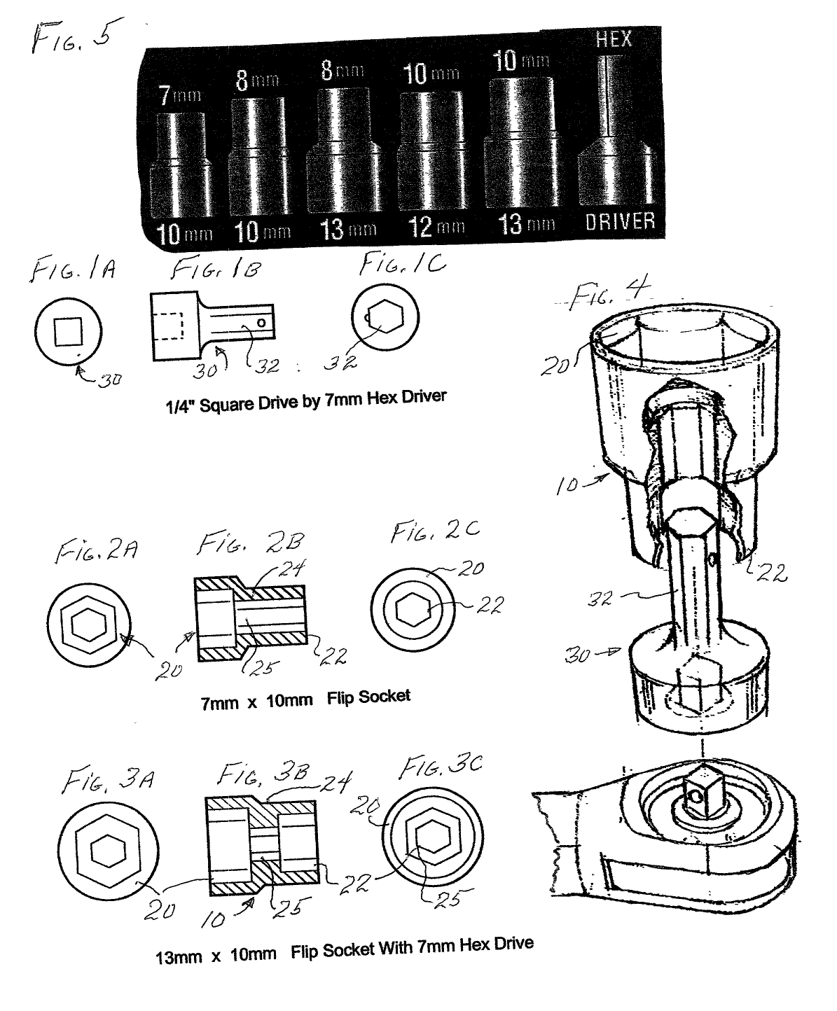

### DESCRIPTION OF A PREFERRED EMBODIMENT

The principle of the invention is applicable to a large variety of socket wrench sizes. For purposes of example a set of five double ended sockets, also called flip sockets, are illustrated in FIG. 5 together with their hex end drive adaptor. The sizes appear at the ends of the socket wrenches to illustrate the range of socket sizes available. These relate to the products of different automotive manufacturers as follows.

| | |
|---|---|
| Imported (from outside USA) | 10 mm/12 mm socket |
| GM | 7 mm/10 mm & 10 mm/13 mm |
| Ford | 8 mm/10 mm & 8 mm/13 mm |
| Chrysler | 10 mm/13 mm. |

In the set shown as exemplary in FIG. 5, the dual socket wrenches are all metric, 7 mm×10 mm, 8 mm×10 mm, 8 mm×13 mm, 10 mm×12 mm and 10 mm×13 mm. Each integral dual socket has an elongated cylindrical body 10 and includes end portions 20 and 22, which are internally formed as coaxially aligned socket wrenches of different size, also formed in longitudinal and coaxial alignment with a central drive socket portion 24 having an internal drive socket 25. These size choices are based upon the “pairing” of certain sizes of bolts and/or hex-head screws by the various auto manufacturers, as shown in the chart above. The disclosed set of five dual socket wrenches, and the associated drive adapter, provides a wide range of utility to the user for work on various different vehicles.

The drive socket 25 in the center of each dual socket (in the illustrated embodiment) is a 7 mm hex, instead of a standard square drive. One of the reasons for this choice is that the 7 mm socket wrench end is too small to receive a standard ¼″ drive end. By using a 7 mm hex drive for the internal drive socket 25 of each dual socket wrench, a ¼″ drive (female) by 7 mm (male) adapter/driver 30 (FIGS. 4 and 5) can be supplied to drive all of the flip sockets in the set with a 7 mm driver head 32, and such adapter can be fitted to various available square drivers (manual or powered). The length of the driver head 32 is sufficient to pass through either of the wrench sockets and properly engage in the internal drive socket of any of the dual sockets in the set.

While the form of socket wrench set herein described constitutes a preferred embodiment of this invention, it is to be understood that the invention is not limited to this precise form of set. Changes may be made therein without departing from the scope of the invention which is defined in the appended claims, such as adapting the principle of the invention to different pairings of dual socket wrenches and/or the provision of sets in English measurements.

What is claimed is:

1. A set of dual socket wrenches having different but related socket wrench sizes, each socket wrench comprising
an elongated body having first and second ends and an intermediate drive portion,
socket wrench cavities of appropriate internal shape formed in each of said first and second ends, the socket wrench cavities being of different related sizes and being coaxially aligned within said body,
a drive socket formed in said intermediate drive portion communicating with said socket wrench cavities, the drive sockets in the set of wrenches having a common internal shape and size and being accessible from each of the adjoining socket wrench cavities.

2. A set of dual socket wrenches as defined in claim 1, further comprising
a drive adaptor for the set of socket wrenches including a driven end for fitting to a drive tool and an opposite driving end having an external shape of the same formation as the drive sockets in all the socket wrenches, said adaptor being of sufficient length to extend through the socket wrench cavities into the drive sockets.

3. A set of dual socket wrenches having different related socket wrench sizes, each socket wrench comprising
a cylindrical body having first and second ends formed as socket wrenches of different and related sizes and an intermediate drive portion internally formed with a drive socket of a size and shape common to all the wrenches of the set, and
a drive adaptor for the set of socket wrenches having an external shape formed to mate with the drive sockets.
